(19) United States
(12) Patent Application Publication
(10) Pub. No.: US 2018/0122255 A1
(43) Pub. Date: May 3, 2018

(54) PLANNING METHOD FOR LEARNING AND PLANNING SYSTEM FOR LEARNING

(71) Applicant: INSTITUTE FOR INFORMATION INDUSTRY, Taipei (TW)

(72) Inventors: Hsiao-Chien TSENG, Yilan County (TW); Chieh-Feng CHIANG, Taoyuan City (TW); Jui-Long HUNG, Tainan City (TW)

(21) Appl. No.: 15/352,533

(22) Filed: Nov. 15, 2016

(30) Foreign Application Priority Data
Nov. 1, 2016 (TW) 105135371

(51) Int. Cl. G09B 5/08; G09B 7/00; G09B 5/02

(52) U.S. Cl. CPC G09B 5/08; G09B 5/02; G09B 7/00

(57) ABSTRACT

A planning method for learning is applied to a planning system for learning, and the planning system for learning includes a monitor, a storage and a processor. The planning method for learning includes operations as follows: recording material-operational information of subjects or recording the material-operational information and test information of the subjects via the monitor; storing the material-operational information or storing the material-operational information and the test information via the storage; when the material-operational information is stored via the storage, establishing a learning plan according to the material-operational information and a learning sequence among the subjects via the processor; and when the material-operational information and the test information are stored via the storage, calculating subject scores of the subjects according to the material-operational information and the test information, and establishing the learning plan according to the subject scores and the learning sequence via the processor.

### RELATED APPLICATIONS

This application claims priority to Taiwan Application Serial Number 105135371, filed Nov. 1, 2016, which is herein incorporated by reference.

### BACKGROUND

### Field of Invention

The present disclosure relates to a data processing system and a data processing method. More particularly, the present disclosure relates to a planning method for learning and a planning system for learning.

### Description of Related Art

With the rapid development of automatic technology, an automatic planning system is widely applied in human life and playing an increasingly important role. For example, a planning system for learning can automatically provide a planning service for learning for a user. However, the current planning system for learning mainly classifies different users into corresponding categories according to test information of the users, and then establishes a learning plan for each of the users according to the categories that the users correspond to. In other words, the current planning system for learning does not consider action of the users during a learning procedure or a test procedure. Therefore, the current planning system for learning is hard to provide an adaptive planning service for learning for the different users, so that quality of user experience of the planning system for learning is thus reduced. Although through analyzing the action of each of the users during the learning procedure or the test procedure to provide the planning service for learning can effectively enhance the quality of user experience of the planning system for learning, this method possibly significantly increases operation complexity of the planning system for learning.

Accordingly, a significant challenge is related to ways in which to enhance the quality of user experience of the planning system for learning while at the same time not increasing the operation complexity of the planning system for learning associated with designing the planning method for learning and the planning system for learning.

### SUMMARY

An aspect of the present disclosure is directed to a planning method for learning which is applied to a planning system for learning, and the planning system for learning includes a monitor, a storage and a processor. The planning method for learning includes operations as follows: recording material-operational information of subjects or recording the material-operational information and test information of the subjects via the monitor; storing the material-operational information or storing the material-operational information and the test information via the storage; when the material-operational information is stored via the storage, establishing a learning plan according to the material-operational information and a learning sequence among the subjects via the processor; and when the material-operational information and the test information are stored via the storage, calculating subject scores of the subjects according to the material-operational information and the test information, and establishing the learning plan according to the subject scores and the learning sequence via the processor.

Another aspect of the present disclosure is directed to a planning system for learning. The planning system for learning includes a monitor, a storage and a processor. The monitor is configured to record material-operational information of subjects or to record the material-operational information and test information of the subjects. The storage is configured to store the material-operational information or to store the material-operational information and the test information. when the storage is configured to store the material-operational information, the processor is configured to establish a learning plan according to the material-operational information and a learning sequence among the subjects; when the storage is configured to store the material-operational information and the test information, the processor is configured to calculate subject scores of the subjects according to the material-operational information and the test information, and to establish the learning plan according to the subject scores and the learning sequence.

It is to be understood that the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block schematic diagram of a planning system for learning according to embodiments of the present disclosure;

FIG. 2 is a flow chart of a planning method for learning according to embodiments of the present disclosure; and

FIG. 3 is a flow chart of a planning method for learning according to embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

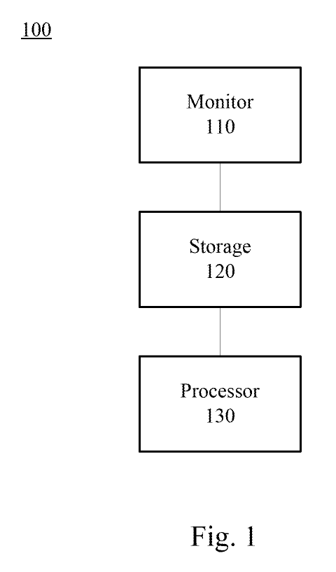

FIG. 1 is a block schematic diagram of a planning system for learning 100 according to embodiments of the present disclosure. As shown in FIG. 1, the planning system for learning 100 includes a monitor 110, a storage 120 and a processor 130. The monitor 110 is electrically connected to the storage 120, and the processor 130 is electrically connected to the storage 120.

The storage 120 can be implemented by using a computer hard drive, a server, or a recording medium that those of ordinary skill in the art can easily think of and has the same function. The monitor 110 can be any actual element that can transform a course of action of a user (includes material-operational information of the subjects and/or test information of the subjects) into recording data. The processor 130 can be implemented by using a central processor, a microcontroller, or a similar element.

The monitor 110 is configured to record material-operational information of subjects or record the material-operational information and test information of the subjects. The storage 120 is configured to store the material-operational information or store the material-operational information and the test information. For example, the monitor 110 can merely record the material-operational information and store the material-operational information in the storage 120, or the monitor 110 can simultaneously record the material-operational information and the test information and store the material-operational information and the test information in the storage 120.

In one embodiment, when the storage 120 is configured to store the material-operational information, the processor 130 is configured to establish a learning plan according to the material-operational information and a learning sequence among the subjects. For example, the material-operational information can be represented as action information of a user during a learning procedure. In this embodiment, the action information during the learning procedure can be represented as user selection among subject materials. Accordingly, the processor 130 can dynamically adjust the learning plan according to the material-operational information and the default learning sequence, so as to provide an adaptive planning service for learning for the user to enhance the quality of user experience of the planning system for learning 100. It should be noted that, the above-mentioned embodiment is merely used for illustrating some possible manners of representing the material-operational information, but the present disclosure is not limited thereto.

In another embodiment, when the storage 120 is configured to store the material-operational information and the test information, the processor 130 is configured to calculate subject scores of the subjects according to the material-operational information and the test information, and to establish the learning plan according to the subject scores and the learning sequence among the subjects. For example, the material-operational information can be represented as action information of a user during a learning procedure, and the test information can be represented as action information of the user during a test procedure or scores of test result. In this embodiment, the action information of the user during the learning procedure can be represented as user selection among subject materials, the number of times that the subject materials are operated by the user or operational time of the subject materials, and the action information of the user during the test procedure can be represented as answer speed of a test. Accordingly, the processor 130 can calculate the subject scores according to the material-operational information and the test information, and dynamically adjust the learning plan according to the subject scores and the default learning sequence, so as to provide an adaptive planning service for learning for the user to enhance the quality of user experience of the planning system for learning 100. It should be noted that, the above-mentioned embodiment is merely used for illustrating some possible manners of representing the material-operational information and the test information, but the present disclosure is not limited thereto.

In one embodiment, the processor 130 is configured to calculate weighting parameters of the subject according to the material-operational information, and to calculate the subject scores of the subject according to the weighting parameters and the test information. For example, the number of times that subject materials are operated by a user is positively correlated with familiarity of the user with the subject materials, and operational time of the subject materials is negatively correlated with the familiarity of the user with the subject materials. Accordingly, the processor 130 can increase the weighting parameters according to the number of the times that the subject materials are operated and a corresponding transfer function, or decrease the weighting parameters according to the operational time of the subject materials and a corresponding transfer function. Subsequently, the processor 130 calculates the subject scores according to the calculated weighting parameters and scores of test result. In another embodiment, if answer speed of a test of a user corresponding to some subjects is excessively fast or excessively slow, the planning system for learning 100 can determine that the user does not have the capabilities to be master of the corresponding subjects, so as to decrease the scores of the test result of the corresponding subjects to adjust the subject scores. For example, the subject scores are positively correlated with capabilities of the user to be master of the corresponding subjects. In other words, high subject scores can represent that the user has the capabilities to be master of the corresponding subjects, and low subject scores can represent that the user does not have capabilities to be master of the corresponding subject. It should be noted that, the above-mentioned embodiment is merely used for illustrating some possible manners of calculating the subject scores, but the present disclosure is not limited thereto.

In one embodiment, when a subject score corresponding to a primary subject of the subjects is smaller than or equal to a first threshold, the processor 130 is configured to establish the learning plan according to the primary subject and the learning sequence. For example, when the subject score corresponding to the primary subject is smaller than or equal to the first threshold, the planning system for learning 100 can determine that a user does not have the capability to be master of the primary subject, so as to adaptively recommend the user to learn the primary subject and prior knowledges of the primary subject according to the primary subject and the default learning sequence.

In another embodiment, when a subject score corresponding to a secondary subject of the subjects is smaller than or equal to a second threshold, the processor 130 is configured to establish the learning plan according to the primary subject, the secondary subject and the learning sequence, and a forward learning sequence is established from the secondary subject to the primary subject. For example, when the forward learning sequence is established from the secondary subject to the primary subject, the planning system for learning 100 can determine that a learning order of the secondary subject should be superior to that of the primary subject. In other words, the secondary subject can be represented as a prior subject of the primary subject. Accordingly, when the subject score corresponding to the primary subject is smaller than or equal to the first threshold, and the subject score corresponding to the secondary subject is smaller than or equal to the second threshold, the planning system for learning 100 can determine that a user does not have the capabilities to be master of the primary subject and the secondary subject, so as to adaptively recommend the user to learn the primary subject, the secondary subject and prior knowledges of the primary subject and the secondary subject according to the primary subject, the secondary subject, and the default learning sequence.

In one embodiment, the monitor 110 is configured to record a learning mode. When the learning mode represents a first mode, the processor 130 is configured to provide subject tests of the subject, so as to generate the learning sequence; when the learning mode represent a second mode, the processor 130 is configured to provide subject materials of the subject, so as to generate the material-operational information. For example, the planning system for learning 100 can provide different learning modes for a user to select. When the user selects the first mode, the planning system for learning 100 can provide a pre-test for the user, and establish the adaptive learning sequence for the user according to the pre-test result. When the user selects the second mode, the planning system for learning 100 can directly provide all of the subject materials for the user, and generate the material-operational information according to the user selection among the subject materials, the number of times that the subject materials are operated or operational time of the subject materials. It should be noted that, the above-mentioned embodiment is merely configured to illustrate some possible manners of implementing the first mode and the second mode of the learning modes, but the present disclosure is not limited thereto. For example, the mode types of the learning modes and the number of learning modes can be adjusted according to practical requirements correspondingly.

In one embodiment, the monitor 110 is configured to update the material-operational information or to update the material-operational information and the test information immediately, and the storage 120 is configured to store the updated material-operational information or to store the updated material-operational information and the updated test information. In another embodiment, the processor 130 is configured to re-establish the learning plan according to the updated material-operational information or according to the updated material-operational information and the updated test information. For example, when the storage 120 is configured to store the updated material-operational information, the processor 130 can dynamically adjust the learning plan according to the updated material-operational information and the default learning sequence; when the storage 120 is configured to store the updated material-operational information and the test information, the processor 130 can re-calculate the subject scores according to the updated material-operational information and the updated test information, and re-establish the learning plan according to the re-calculated subject scores and the learning sequence.

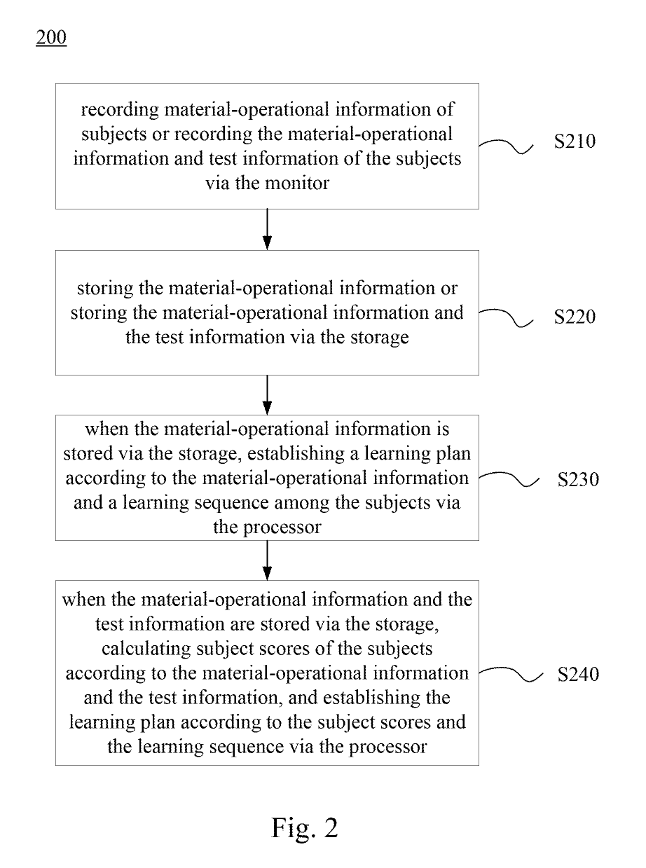

FIG. 2 is a flow chart of a planning method for learning 200 according to embodiments of the present disclosure. In one embodiment, the planning method for learning 200 can be implemented by the planning system for learning 100, but the present disclosure is not limited thereto. For facilitating the understanding of the planning method for learning 200, the planning system for learning 100 is used as an example for illustrating the planning method for learning 200 as follows. As shown in FIG. 2, the planning method for learning 200 includes operations as follows:
S210: recording material-operational information of subjects or recording the material-operational information and test information of the subjects via the monitor 110;
S220: storing the material-operational information or storing the material-operational information and the test information via the storage 120;
S230: when the material-operational information is stored via the storage 120, establishing a learning plan according to the material-operational information and a learning sequence among the subjects via the processor 130; and
S240: when the material-operational information and the test information are stored via the storage 120, calculating subject scores of the subjects according to the material-operational information and the test information, and establishing the learning plan according to the subject scores and the learning sequence via the processor 130.

In one embodiment, reference now is made to the operation S230, and the material-operational information can be represented as action information of a user during a learning procedure. In this embodiment, the action information during the learning procedure can be represented as user selection of subject materials. Accordingly, the planning method for learning 200 can be performed by the processor 130 to dynamically adjust the learning plan according to the material-operational information and the default learning sequence, so as to provide an adaptive planning service for learning for a user to enhance the quality of user experience of the planning system for learning 100. It should be noted that, the above-mentioned embodiments is merely configured to illustrate some possible manners of representing the material-operational information, but the present disclosure is not limited thereto.

In another embodiment, reference now is made to the operation S240, the material-operational information can represented as action information of a user during a learning procedure, and the test information can be represented as action information of the user during a test procedure or scores of test result. In this embodiment, the action information of the user during the learning procedure can be represented as user selection among subject materials, the number of times that the subject materials are operated or operational time of the subject materials, and the action information of the user during the test procedure can be represented as answer speed of a test. Accordingly, the planning method for learning 200 can be performed by the processor 130 to calculate the subject scores according to the material-operational information and the test information, and to dynamically adjust the learning plan according to the subject scores and the default learning sequence, so as to provide an adaptive planning service for learning for user to enhance the quality of user experience of the planning system for learning 100. Since the above-mentioned embodiment is used for detailed illustrating some possible manners of calculating the subject scores, so will not be repeated. It should be noted that, the above-mentioned embodiment is used for illustrating some possible manners of representing the material-operational information and the test information, but the present disclosure is not limited thereto.

In one embodiment, reference now is made to the operation S240, when a subject score corresponding to a primary subject of the subjects is smaller than or equal to a first threshold, establishing the learning plan according to the primary subject and the learning sequence via the processor 130. For example, when the subject score corresponding to the primary subject is smaller than or equal to the first threshold, the planning method for learning 200 can be performed by the processor 130 to determine that a user does not have the capability to be master of the primary subject, so as to adaptively recommend the user to learn the primary subject and prior knowledges of the primary subject according to the primary subject and the default learning sequence.

In another embodiment, reference now is made to the operation S240, when a subject score corresponding to a secondary subject of the subjects is smaller than or equal to a second threshold, establishing the learning plan according to the primary subject, the secondary subject and the learning sequence via the processor 130, and a forward learning sequence is established from the secondary subject to the primary subject. For example, when the forward learning sequence is established from the secondary subject to the primary subject, the planning method for learning 200 can be performed by the processor 130 to determine that a learning order of the secondary subject should be superior to that of the primary subject. In other words, the secondary subject can be represented as a prior subject of the primary subject. Accordingly, when the subject score corresponding to the primary subject is smaller than or equal to the first threshold, and the subject score corresponding to the secondary subject is smaller than or equal to the second threshold, the planning method for learning 200 can be performed by the processor 130 to determine that a user does not have the capability to be master of the primary subject and the secondary subject, so as to adaptively recommend the user to learn the primary subject, the secondary subject and prior knowledges of the primary subject and the secondary subject according to the primary subject, the secondary subject, and the default learning sequence.

In one embodiment, the planning method for learning 200 can be performed by the monitor 110 to record a learning mode. When the learning mode represents a first mode, providing subject tests of the subjects via the processor 130, so as to generate the learning sequence; when the learning mode represent a second mode, providing subject materials of the subjects via the processor 130, so as to generate the material-operational information. For example, when a user selects the first mode, the planning method for learning 200 can be performed by the processor 130 to provide a pre-test for the user, and to establish the adaptive learning sequence for the user according to the pre-test result. When the user selects the second mode, the planning method for learning 200 can be performed by the processor 130 to directly provide all of the subject materials for the user to select, and generate the material-operational information according to user selection among the subject materials, the number of times that the subject materials are operated or operational time of the subject materials. It should be noted that, the above-mentioned embodiment is used for illustrating some possible manners of implementing the different learning modes, but the present disclosure is not limited thereto. For example, the mode types of the learning modes and the number of the learning modes can be adjusted according to practical requirements correspondingly.

In one embodiment, the planning method for learning 200 can be performed by the monitor 110 to update the material-operational information or to update the material-operational information and the test information immediately, and the planning method for learning 200 can be performed by the storage 120 to store the updated material-operational information or to store the updated material-operational information and the updated test information. In another embodiment, the planning method for learning 200 can be performed by the processor 130 to re-establish the learning plan according to the updated material-operational information or according to the updated material-operational information and the updated test information. For example, after the updated material-operational information is stored in the storage 120, the processor 130 can dynamically adjust the learning plan according to the updated material-operational information and the default learning sequence; after the updated material-operational information and the updated test information are stored in the storage 120, the processor 130 can re-calculate the subject scores according to the updated material-operational information and the updated test information, and re-establish the learning plan according to the re-calculated subject scores and the learning sequence.

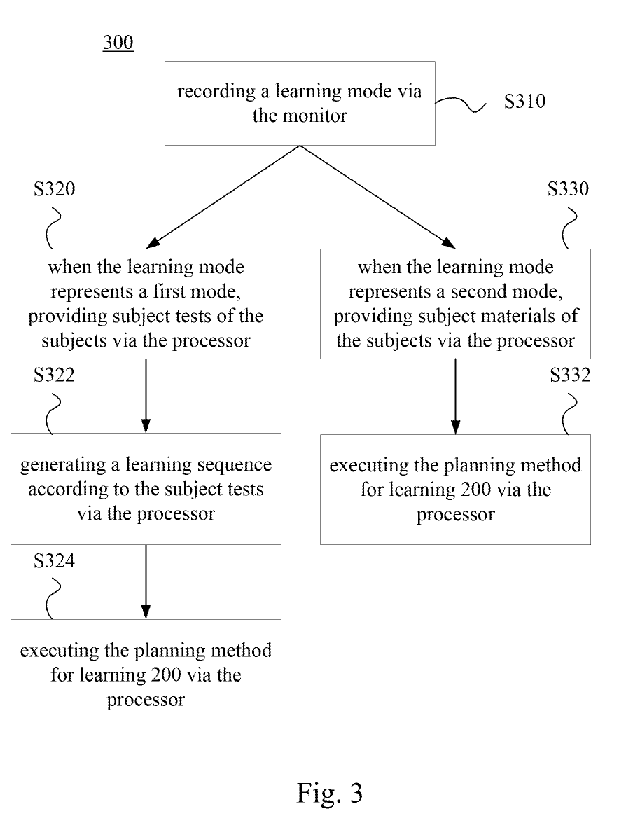

FIG. 3 is a flow chart of a planning method for learning 300 according to embodiments of the present disclosure. In one embodiment, a difference between the planning method for learning 300 and the planning method for learning 200 is that selection of the learning modes is implemented in the planning method for learning 300. Accordingly, the planning method for learning 300 can also be implemented by the planning system for learning 100, but the present disclosure is not limited thereto. For facilitating the understanding of the planning method for learning 300, the planning system for learning 100 is used as an example for illustrating the planning method for learning 300 as follows. As shown in FIG. 3, the planning method for learning 300 includes operations as follow:
S310: recording a learning mode via the monitor 110;
S320: when the learning mode represents a first mode, providing subject tests of the subjects via the processor 130;
S322: generating a learning sequence according to the subject tests via the processor 130;
S324: executing the planning method for learning 200 via the processor 130;
S330: when the learning mode represents a second mode, providing subject materials of the subjects via the processor 130; and
S334: executing the planning method for learning 200 via the processor 130.

For example, when a user selects the first mode, the planning method for learning 300 can be performed by the processor 130 to establish the adaptive learning sequence for a user according to result of the subject tests, and to execute the planning method for learning 200 to provide the subsequent planning service for learning for the user; when the user selects the second mode, the planning method for learning 300 can be performed by the processor 130 to directly provide all of the subject materials for the user to help user for autonomous learning, and to execute the planning method for learning 200 to provide the subsequent planning service for learning for the user. Since the above-mentioned embodiment is used for detailed illustrating some possible manners of implementing the first mode and the second mode of the learning modes, so will not be repeated. It should be noted that, the above-mentioned embodiment is merely used for illustrating some possible manners of implementing the learning mode, but the present disclosure is not limited thereto. For example, the mode types of the learning modes and the number of the learning modes can be adjusted according to practical requirements correspondingly.

As mentioned above, the planning method for learning and the planning system for learning disclosed in the present disclosure establish the learning plan for a user directly according to the material-operational information via the processor, or calculate the subject scores according to the material-operational information and the test information, so as to establish the learning plan for the user via the processor. For example, the material-operational information can be represented as action information of a user during a learning procedure, and the test information can be represented as action information of the user during a test procedure and test result. Accordingly, the planning method for learning and the planning system for learning disclosed in the present disclosure can provide an adaptive planning service for learning for different users merely according to the material-operational information or simultaneously according to the material-operational information and the test information to enhance the quality of user experience of the planning system for learning. Furthermore, the planning method for learning and the planning system for learning disclosed in the present disclosure can efficiently analyze the material-operational information or the test information according to user requirements, so as to remain operation complexity of the planning system for learning.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present invention cover modifications and variations of this present disclosure provided they fall within the scope of the following claims.

What is claimed is:

1. A planning method for learning, applied to a planning system for learning, wherein the planning system for learning comprises a monitor, a storage and a processor, and the planning method for learning comprises:
recording material-operational information of a plurality of subjects or recording the material-operational information and test information of the subjects via the monitor;
storing the material-operational information or storing the material-operational information and the test information via the storage;
when the material-operational information is stored via the storage, establishing a learning plan according to the material-operational information and a learning sequence among the subjects via the processor; and
when the material-operational information and the test information are stored via the storage, calculating subject scores of the subjects according to the material-operational information and the test information, and establishing the learning plan according to the subject scores and the learning sequence via the processor.

2. The planning method for learning of claim 1, wherein calculating the subject scores of the subjects according to the material-operational information and the test information, and establishing the learning plan according to the subject scores and the learning sequence via the processor comprises:
when a subject score corresponding to a primary subject of the subjects is smaller than or equal to a first threshold, establishing the learning plan according to the primary subject and the learning sequence via the processor.

3. The planning method for learning of claim 2, wherein calculating the subject scores of the subjects according to the material-operational information and the test information, and establishing the learning plan according to the subject scores and the learning sequence via the processor comprises:
when a subject score corresponding to a secondary subject of the subjects is smaller than or equal to a second threshold, establishing the learning plan according to the primary subject, the secondary subject and the learning sequence via the processor, wherein a forward learning sequence is established from the second subject to the first subject.

4. The planning method for learning of claim 1, further comprising:
recording a learning mode via the monitor;
when the learning mode represents a first mode, providing subject tests of the subjects via the processor, so as to generate the learning sequence; and
when the learning mode represents a second mode, providing subject materials of the subjects via the processor, so as to generate the material-operational information.

5. The planning method for learning of claim 1, further comprising:
updating the material-operational information or updating the material-operational information and the test information immediately via the monitor;
storing the updated material-operational information or storing the updated material-operational information and the updated test information via the storage;
re-establishing the learning plan according to the updated material-operational information or according to the updated material-operational information and the updated test information via the processor.

6. A planning system for learning, comprising:
a monitor, configured to record material-operational information of a plurality of subjects or to record the material-operational information and test information of the subjects;
a storage, configured to store the material-operational information or to store the material-operational information and the test information; and
a processor, wherein when the storage is configured to store the material-operational information, the processor is configured to establish a learning plan according to the material-operational information and a learning sequence among the subjects; when the storage is configured to store the material-operational information and the test information, the processor is configured to calculate subject scores of the subjects according to the material-operational information and the test information, and to establish the learning plan according to the subject scores and the learning sequence.

7. The planning system for learning of claim 6, wherein when a subject score corresponding to a primary subject of the subjects is smaller than or equal to a first threshold, the processor is configured to establish the learning plan according to the primary subject and the learning sequence.

8. The planning system for learning of claim 7, wherein when a subject score corresponding to a secondary subject of the subjects is smaller than or equal to a second threshold, the processor is configured to establish the learning plan according to the primary subject, the secondary subject and the learning sequence, wherein a forward learning sequence is established from the second subject to the first subject.

9. The planning system for learning of claim 6, wherein the monitor is configured to record a learning mode, when the learning mode represents a first mode, the processor is configured to provide subject tests of the subjects, so as to generate the learning sequence; when the learning mode represents a second mode, the processor is configured to provide subject materials of the subjects, so as to generate the material-operational information.

10. The planning system for learning of claim 6, wherein the monitor is configured to update the material-operational information or to update the material-operational information and the test information immediately, the storage is configured to store the updated material-operational information or to store the updated material-operational information and the updated test information, and the processor is configured to re-establish the learning plan according to the updated material-operational information or according to the updated material-operational information and the updated test information.
